(19) United States
(12) Patent Application Publication
(10) Pub. No.: US 2003/0069977 A1
(43) Pub. Date: Apr. 10, 2003

(54) Method and system for identifying and providing additional information about an article to the visually impaired

(75) Inventor: Gary M. Heiden, Shelton, CT (US)

Correspondence Address: Pitney Bowes Inc., Intellectual Property and Technology Law Dept., 35 Waterview Drive, P.O. Box 3000, Shelton, CT, 06484, US

(73) Assignee: Pitney Bowes Incorporated, Stamford, CT

(21) Appl. No.: 09/974,087

(22) Filed: Oct. 9, 2001

(51) Int. Cl. G06F 15/16; G10L 21/06

(52) U.S. Cl. 709/227; 704/271

(57) ABSTRACT

A method and system for assisting the visually impaired to identify the contents of an object or container and any important information related thereto is provided. When a container, such as, for example, a bottle or envelope, for an article is prepared, a barcode that includes data related to the contents of the container is generated. The generated barcode is printed on the container, or printed on a label secured to the container. A reading device is utilized to scan the barcode. The information included in the barcode is converted into an audible format, and provided by the reading device in an audible speech format thereby allowing a visually impaired person to hear the information regarding the container and/or its contents. Additionally, the reading device can obtain and audibly present additional detailed information related to the article via an on-line service.

### FIELD OF THE INVENTION

The invention disclosed herein relates generally to barcode scanning devices, and more particularly to utilizing a barcode and scanning device to identify and provide additional information about articles to the visually impaired.

### BACKGROUND OF THE INVENTION

There are currently many devices that assist visually impaired persons to perform various tasks that enable them to lead independent, productive lives. For example, devices exist which assist the visually impaired to read printed text. These devices, however, are not suitable for use to assist the visually impaired to identify the contents of an object or container and any important information related thereto.

For example, many prescription and over-the-counter drugs are often administered in the form of pills that are contained in bottles or containers. Many people often take or ingest more than one type of drug to treat different conditions. Bottles and containers used for such drugs are frequently of the same size even though the may contain quite different, and even incompatible, medications. It is important to take the correct drugs in the correct dosage to ensure optimal results and to prevent an accidental overdose. Additionally, as already noted, some drugs can not be combined with others, as interaction between them could either reduce the efficiency of the drugs, or, in worst case, result in substantial harm to or even death of the user. To assist the user in the proper taking of prescription and over-the-counter type drugs, they are often provided with detailed written labels attached to the container that identify, for example, the type of drug, the frequency of use, and any precautions for use. While these labels may be easily read visually, visually impaired people are generally unable to obtain this vital information. While the use of labels having Braille information will provide some assistance to the visually impaired, the amount of information that can be included on such labels is limited due to space constraints.

Another example of an area where there are no suitable devices to assist the visually impaired to identify the contents of an object or container and any important information related thereto is the receipt of mail. A visually impaired person may not be able to identify or read a received mail piece. For example, a visually impaired person will not know the date the mail piece was sent, who sent the mail piece, who is the actual addressee, and if it requires immediate attention, until he can find someone to read the mail piece to him.

Thus, there exists a need for a method and system for assisting the visually impaired to identify the contents of an object or container and any important information related thereto.

### SUMMARY OF THE INVENTION

The present invention alleviates the problems associated with the prior art and provides a method and system for assisting the visually impaired to identify the contents of an object or container and any important information related thereto.

In accordance with the present invention, when a container, such as, for example, a bottle or envelope, for an article is prepared, a barcode, such as, for example, a 2D barcode, is generated. The barcode includes data related to the contents of the container, such as, for example, the human readable information that is typically provided on the container. The generated barcode is printed on the container, or printed on a label secured to the container. A reading device is utilized to scan the barcode. The information included in the barcode is converted into an audible format, and provided by the reading device in a speech format thereby allowing a visually impaired person to hear the information regarding the container. Additionally, the reading device can obtain additional detailed information related to the article via an on-line service. The generated barcode includes a link to a Web service that can be accessed by the reading device. Information provided by the Web service is presented via the speech synthesis of the reading device. Accordingly, a visually impaired person will be provided with an identification of the article as well as additional information related to the article in a speech format.

### DESCRIPTION OF THE DRAWINGS

The above and other objects and advantages of the present invention will be apparent upon consideration of the following detailed description, taken in conjunction with accompanying drawings, in which like reference characters refer to like parts throughout, and in which:

FIG. 1 illustrates in block diagram form a system for identifying and obtaining additional information about an article according to the present invention; and

FIG. 2 illustrates in flow diagram form a process of identifying and obtaining additional information about an article according to the present invention.

### DETAILED DESCRIPTION OF THE PRESENT INVENTION

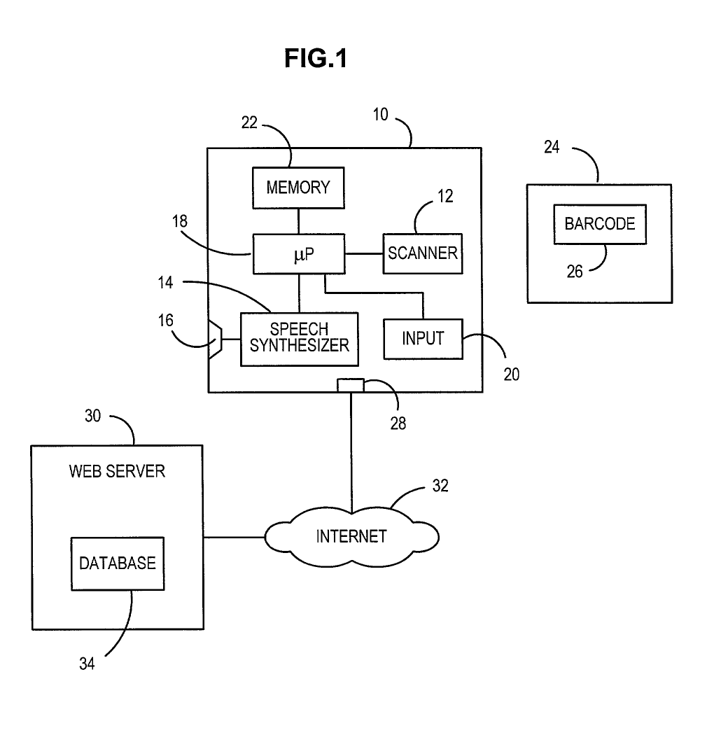

In describing the present invention, reference is made to the drawings, wherein there is seen in FIG. 1 a system for identifying and obtaining additional information about an article for the visually impaired according to the present invention. The system includes a reading device 10. Reading device 10 can be a stand-alone device or could be incorporated as part of a personal computer (PC). Reading device 10 includes a scanner 12 coupled to a processor, such as, for example, microprocessor 18. Processor 18 has an associated memory 22. Reading device 10 further includes a speech synthesizer 14 coupled to a speaker 16 for outputting the synthesized speech in an audible format from reading device 10. Reading device 10 may also include an input device 20, such as, for example, a keyboard.

Reading device 10 may also include a communication port 28 that provides a communication link to a Web server 30. The communication link may be provided, for example, via the Internet 32. Web server 30 includes one or more databases 34 for storing information as will be further described below. Web server 30 provides additional value added services to a user of the reading device 10 as will be further described below.

Scanner 12 of reading device 10 is used to scan a barcode 26 provided on an article 24. Article 24 could be, for example, any type of container such as a pill bottle, envelope, package, etc. Barcode 26 is preferably a 2D barcode that includes data related to the article 24 or the contents therein. For example, if article 24 is a bottle containing a prescription drug, barcode 26 could include information that is typically printed on a label and secured to the bottle. Such information may include, for example, the name of the patient, type of medication, dosage requirements, name and telephone number of the doctor that prescribed the medication, name and telephone number of the pharmacy that dispensed the medication, identification number of the prescription, important instructions or warnings for taking the medication, number of refills remaining, expiration of the medication, etc.

If article 24 is, for example, an envelope or package, barcode 26 could include information that is typically printed on the envelope or package or a label affixed thereto. Such information could include, for example, the name of the sender, the name of the recipient, the date of delivery, or contents of the envelope, i.e., invoice, special offer, dated material, etc.

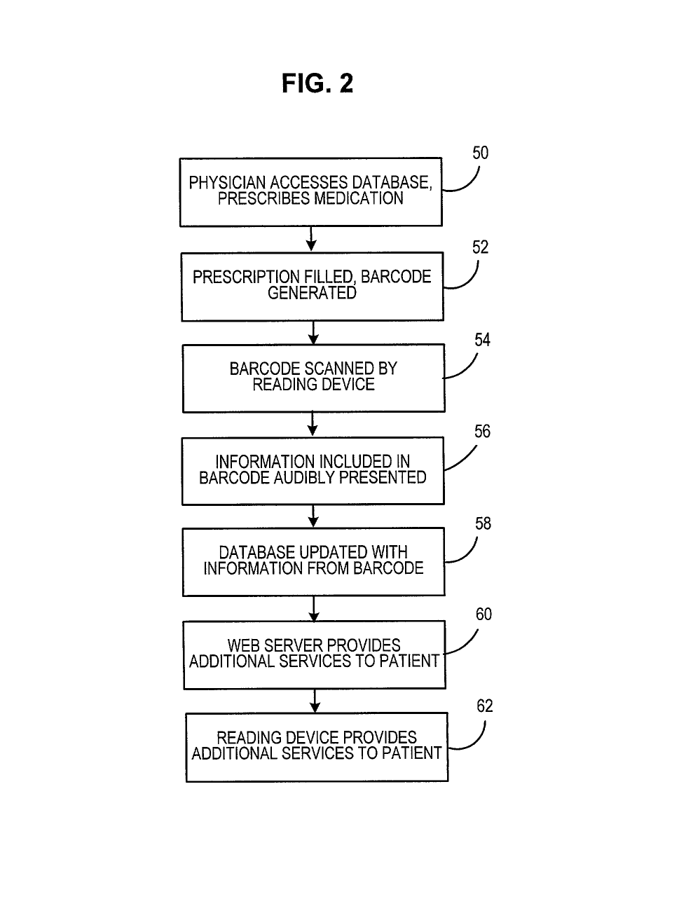

The operation of the system illustrated in FIG. 1 will now be described with respect to the flow diagram of FIG. 2. Specifically, FIG. 2 illustrates the process flow for identifying and obtaining additional information about an article 24 for the visually impaired where the article 24 is a container for a prescription medication. It should be noted, however, that this example is illustrative only; the present invention is not so limited and can be used with any type of article.

According to the present invention, database 34 of Web server 30 is utilized to store information related to an individual's medical history, such as, for example, current medications, past medications, etc. Accordingly, the individual need not remember the names, dates of ingestion, etc. associated with any medications previously taken. The database 34 is updated as each new medication is prescribed as described below. Referring now to FIG. 2, when a physician is prescribing a new medication for a patient, in step 50 the physician will access that patient's record stored in database 34 of Web server 30. Such access can be performed, for example, via the Internet 32 or any other accessing means. The information stored in database 34 for that patient will provide the physician with the patient's current medication status and medication history, thereby allowing the physician to discuss any potential interactions with other medications or to prescribe a medication that may be better suited for the patient. The physician prescribes a medication and the prescription is delivered to a pharmacy for filling. Such delivery may be either via the patient, electronically directly from the physician to the pharmacy via a secure channel with authentication, or any other suitable delivery means.

In step 52, the prescription is filled by the pharmacy. A conventional printed human-readable label is prepared and secured to the container 24 of the prescription. According to the present invention, a barcode 26 is also generated when the prescription is filled. Preferably, the barcode 26 is a 2D barcode such that greater amounts of data can be encoded within the barcode as compared to 1D barcodes. Barcode 26 can be printed on the same stock and at the same time as the printed human-readable label, or could be separately printed and secured to container 24. The information included in the barcode 26 is similar to that included in the printed human-readable label and can include, for example, the name of the patient, type of medication, dosage requirements, name and telephone number of the doctor that prescribed the medication, name and telephone number of the pharmacy that dispensed the medication, identification number of the prescription, important instructions or warnings for taking the medication, number of refills remaining, expiration of the medication, etc. Additionally, the barcode 26 includes an address for Web server 30. It should be noted that additional information may be included in the barcode 26, and that all of the information on the printed human-readable label need not be included in the barcode 26.

In step 54, when the patient receives the container 24 of the filled prescription, the patient scans the barcode 26 of container 24 using the scanner 12 of reading device 10. The data included in the barcode 26 is processed by processor 18 and sent to speech synthesizer 14. In step 56 speech synthesizer 14 will then audibly present the data included in barcode 26 via speaker 16. Thus, a person unable to read the printed human-readable label will still be able to audibly retrieve the information associated with the prescription by scanning the barcode 26.

In step 58, reading device 10 communicates with Web server 30 and updates the record for the patient maintained in database 34 of Web server 30 to include the information about the current prescription obtained from the barcode 26. Such communication may be triggered automatically by reading device 10, or may be manually triggered by the patient. Automatic triggering can occur, for example, each time a new barcode 26 is scanned into the system, by the time of day, day of the week, etc. Additionally, a local record for the patient may be kept in the memory 22 of reading device 10.

Once a communication has been established between the reading device 10 and Web server 30, Web server 30 can provide additional value added services to the patient. For example, in step 60 additional information associated with the prescription can be provided by the Web server 30 to the reading device 10 and output to the patient in audible format. Such information could include, for example, possible interactions with any other medications currently being taken, as determined by the information stored in database 34. The information could also include, for example, detailed information about the current prescription that is not included in the data of the barcode 26. Additionally, Web server 30 could also maintain additional records in database 34 with respect to monitoring the consumption of the prescription by the patient. Such information could be input by the patient via input device 20 of reading device 10 and sent to Web server 30. Web server 30 will maintain a record of when the medication has been consumed, when the medication should be next taken, and when a refill should be ordered. When a refill is necessary, Web server 30 could initiate an on-line reverse auction for quotes to provide the refill and provide the best price to the patient audibly via reading device 10.

Reading device 10 could also be utilized to provide one or more of the additional value added services to the patient. For example, in step 62, the reading device could be used to monitor the consumption of the medication. The data maintained in memory 22 of reading device 10 can be updated by the patient via input from input device 20 as the patient consumes the medication. Reading device 10 will maintain a record of when the medication has been consumed, when the medication should be next taken, and when a refill should be ordered. When a refill is necessary, reading device 10 could initiate an on-line reverse auction for quotes to provide the refill and audibly provide the best price to the patient.

Thus, according to the present invention, a method and system for identifying and obtaining additional information about a medication prescription for the visually impaired is provided. It should be noted, however, that the method and system of the present invention is not limited to the above example and may be used for identifying and providing information about any type of article. For example, the present invention could also be utilized with the sending of mail. When a mail piece, such as, for example, an envelope or package, is prepared for sending, a barcode is generated that includes information related to the mail piece. Such information could include, for example, the name and address of the addressee, name and address of the sender, information related to the contents of the envelope or package, etc. Additionally, other information could also be included, such as, for example, advertising or the address of one or more Web servers or sites. If a written message is included in the envelope or package, the message could be stored in a database of a Web server. The generated barcode is printed or secured to the outside of the mail piece. When the recipient receives the mail piece, the barcode is scanned by reading device and the information included in the barcode is audibly presented to the recipient. Additionally, reading device could communicate with one or more Web servers, as determined by the addresses included in barcode, and the stored message could be audibly presented to the mail piece recipient. Additionally, the Web servers could be used to provide additional information or other services to the recipient.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A method for audibly providing information about an article comprising the steps of:
generating a barcode, said barcode including said information about said article;
affixing said barcode to said article;
scanning said barcode to retrieve said information;
converting said information into an audible format; and
providing said information in said audible format.

2. The method according to claim 1, wherein said step of affixing further comprises:
printing said barcode on said article.

3. The method according to claim 1, wherein said step of affixing further comprises:
printing said barcode on a label; and
securing said label to said article.

4. The method according to claim 1, wherein said article is a container, and said information includes information about a contents of said container.

5. The method according to claim 4, wherein said container is a mail piece, and said contents of said mail piece includes a written message.

6. The method according to claim 4, wherein said contents of said container is medication.

7. The method according to claim 1, wherein said barcode is a 2D barcode.

8. The method according to claim 1, further comprising:
updating a database with at least a portion of said information.

9. A method for audibly providing information related to contents of a container comprising the steps of:
generating a barcode, said barcode including an address for a Web site, said Web site maintaining said information related to said container;
affixing said barcode to said container;
scanning said barcode to retrieve said Web site address;
communicating with said Web site to retrieve said information related to said contents of said container; and
audibly presenting said information related to said contents of said container retrieved from said Web site.

10. The method according to claim 9, wherein said barcode further includes at least a portion of said information related to said contents, and said method further comprises:
converting said at least a portion of said information into an audible format; and
outputting said at least a portion of said information in said audible format.

11. The method according to claim 10, wherein said contents of said container includes a medication, and said at least a portion of said information includes at least one of a name of said medication, instructions for taking said medication, and a name of a physician that prescribed said medication.

12. The method according to claim 10, wherein said container is a mail piece and said contents includes a written message, and said information retrieved from said Web site includes at least a portion of said written message.

13. The method according to claim 12, wherein said at least a portion of said information includes at least one of an addressee's name, a sender's name, and a mailing date of said mail piece.

14. A method for audibly providing information related to a medication comprising the steps of:
generating a barcode, said barcode including information related to said medication;
affixing said barcode to a container holding said medication;
scanning said barcode to retrieve said information;
converting said information into an audible format;
outputting said converted information in said audible format;
communicating with a Web site, said Web site being selected based on an address included in said barcode;
retrieving additional information related to said medication from said Web site; and
outputting said additional information retrieved from said Web site in an audible format.

15. The method according to claim 14, further comprising:
updating a database to include said medication.

16. The method according to claim 15, further comprising:
monitoring consumption of said medication utilizing said database.

17. The method according to claim 16, further comprising:
determining when a refill of said medication is necessary based on said monitored consumption.

18. The method according to claim 17, further comprising:
determining a price for refilling said medication.

19. A device for audibly providing information related to an article comprising:
a processor;
a scanner coupled to said processor, said scanner adapted to scan a barcode attached to said article, said barcode including said information related to said article;
a speech synthesizer coupled to said processor, said speech synthesizer adapted to convert said information included in said barcode to an audible format; and
a speaker to output said converted information in said audible format.

20. The device according to claim 19, further comprising:
a memory coupled to said processor, said memory adapted to store at least a portion of said information included in said barcode.

21. The device according to claim 20, further comprising:
an input device to update said at least a portion of said information stored in said memory.

22. The device according to claim 19, further comprising:
a communication port to communicate with a Web server, said Web server providing additional information related to said article to said device, said device outputting said additional information in an audible format via said speaker.

23. The device according to claim 19, wherein said barcode is a 2D barcode.

24. The device according to claim 19, wherein said device is integral to a personal computer.

25. The device according to claim 19, wherein said article is a container of medication, and said information is related to said medication.

26. The device according to claim 25, wherein said information includes at least one of a name of said medication, instructions for taking said medication, and a name of a physician that prescribed said medication.

27. The device according to claim 19, wherein said article is a mail piece.

28. The device according to claim 27, wherein said information includes at least one of an addressee's name, a sender's name, and a mailing date of said mail piece.

29. A system for audibly providing information related to an article, said system comprising:
a Web server to maintain a first portion of said information related to said article; and
a reading device adapted to communicate with said Web server, said reading device comprising:
a processor;
a scanner coupled to said processor, said scanner adapted to scan a barcode attached to said article, said barcode including an address of said Web server and a second portion of said information related to said article, said reading device communicating with said Web server based on said address of said Web server included in said barcode and retrieving said first portion of said information related to said article;
a speech synthesizer coupled to said processor; and
a speaker coupled to said speech synthesizer,
wherein said speech synthesizer converts said second portion of said information related to said article included in said barcode to an audible format and said speaker outputs said converted second portion of said information and said first portion of said information retrieved from said Web site in an audible format.

30. The system according to claim 29, wherein said reading device further comprises:
a memory coupled to said processor, said memory adapted to store portions of said information related to said article.

31. The system according to claim 30, wherein said reading device further comprises:
an input device to update said information stored in said memory.

32. The system according to claim 29, wherein said barcode is a 2D barcode.

33. The system according to claim 29, wherein said reading device is integral to a personal computer.

34. The system according to claim 29, wherein said article is a container of medication, and said information is related to said medication.

35. The system according to claim 34, wherein said information includes at least one of a name of said medication, instructions for taking said medication, and a name of a physician that prescribed said medication.

36. The system according to claim 29, wherein said article is a mail piece.

37. The system according to claim 36, wherein said information includes at least one of an addressee's name, a sender's name, and a mailing date of said mail piece.
